(19) United States
(12) Patent Application Publication
(10) Pub. No.: US 2006/0127094 A1
(43) Pub. Date: Jun. 15, 2006

(54) Wavelength division multiple access central station, wavelength division multiple access user interface, and optical layer connection service method in optical network using wavelength division multiple access scheme

(76) Inventor: Sung Hoon Kwak, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/213,459

(22) Filed: Aug. 26, 2005

(30) Foreign Application Priority Data
Dec. 10, 2004 (KR) 2004-104325
May 17, 2005 (KR) 2005-41039

(51) Int. Cl. H04J 14/02

(52) U.S. Cl. 398/89

(57) ABSTRACT

Provided are a wavelength division multiple access (WDMA) central station, a WDMA user interface, and an optical layer connection service method in an optical network using a WDMA scheme. The WDMA central station for an optical layer connection service in an optical network using a WDMA scheme, includes: a WDMA connection unit for receiving optical signals transmitted from a plurality of WDMA user interfaces, distributing and selecting the optical signals, and transmitting the distributed and selected optical signals to a plurality of user stations; and a network controller unit for transceiving control information related to optical layer connection and network status information received from the plurality of WDMA user interfaces through the WDMA connection unit, wherein an optical layer connection service is provided according to request quality of the plurality of user stations.

### CROSS-REFERENCE TO RELATED APPLICATION

This application claims priority to and the benefit of Korean Patent Application No. 2004-104325, filed Dec. 10, 2004 and Korean Patent Application No. 2005-41039, filed May 17, 2005, the disclosure of which is incorporated herein by reference in its entirety.

### BACKGROUND

1. Field of the Invention

The present invention relates to a wavelength division multiple access (WDMA) central station, a WDMA user interface, and an optical layer connection service method in an optical network using a WDMA scheme and, more particularly to, a WDMA central station, a WDMA user interface, and an optical layer connection service method in an optical network using a WDMA scheme which can provide security, stability, traffic monitoring, and fast connection service over an entire network through a centralized control structure and also provide an optical layer connection service differentiated according to a request of a user station through medium access control (MAC) which is protocol-transparent with an upper layer.

2. Discussion of Related Art

In recent years, as broadcasting and communication are merged and personal cellular phones and digital home appliances are rapidly developed, an optical network is required to accommodate various kinds of traffic. Also, the quantity of traffic is rapidly increased every year.

Most of existing optical networks perform only high-speed data transmission between the metropolises or continents. Research and development on the optical network have focused on performance improvement of optical elements for ultra high-speed long distance transmission rather than networking technology in the optical layer. As the representative optical element for ultra high-speed long distance transmission, there are a low-loss optical fiber, a high-speed optical transceiver, a wavelength multiplexer, a wavelength demultiplexer, and an optical amplifier.

However, the future optical network should not play a role of only a network for ultra high-speed long distance transmission of a point-to-point method. It is because various user stations are directly connected to the optical network through the optical interface to require the optical network to have a configuration of a local area network (LAN), a metropolitan area network (MAN), and a storage area network (SAN).

Further, the future optical network should be able to provide a networking function such as traffic monitoring, connection control and network management in the optical layer such that the connection service. differentiated according to a user station's demand as well as high speed long distance transmission can be provided.

Meanwhile, the conventional optical network using the wavelength division multiple access (WDMA) scheme adds only wavelength information to a medium access control (MAC) scheme such as a time division multiple access (TDMA) scheme or token ring scheme which is used in the existing electric network to provide a connection service in the optical layer.

That is, the connection service in the optical layer has wholly depended on an extended protocol of the upper date transmission layer. The WDMA optical network has a distributed structure in which the respective user stations individually perform the MAC protocol, and thus it has a disadvantage in that it is weak in security, stability, traffic monitoring, and rapid connection service provision.

### SUMMARY OF THE INVENTION

The present invention is directed to a wavelength division multiple access (WDMA) central station, a WDMA user interface, and an optical layer connection service method in an optical network using a WDMA scheme which can implement the WDMA user interface which has quality stability of an optical signal and short connection setting time, and are low in cost and simple, provide network security and stability, traffic monitoring, and fast connection service through a centralized management and control structure, and provide a protocol-transparent and differentiated optical connection service by employing an independent in-banding signaling method from an upper layer.

A first aspect of the present invention is to provide a WDMA central station for an optical layer connection service in an optical network using a WDMA scheme, including: a WDMA connection unit for receiving optical signals transmitted from a plurality of WDMA user interfaces, distributing and selecting the optical signals, and transmitting the distributed and selected optical signals to a plurality of user stations; and a network controller unit for transceiving control information related to optical layer connection and network status information received from the plurality of WDMA user interfaces through the WDMA connection unit, wherein an optical layer connection service is provided according to request quality of the plurality of user stations.

The WDMA connection unit may include a N×N passive star coupler for distributing power of respective input optical signals connected to the plurality of WDMA user interfaces in a WDMA manner by 1/N to respective output ports; and a plurality of wavelength selection units for converting the optical signals distributed from the output ports of the N×N passive star coupler into a wavelength demultiplexing and electrical signal, and selecting any one of the converted electrical signal and an electrical signal provided from the network controller unit to convert the selected signal into an optical signal with an inherent wavelength which is already allocated and transmit the optical signal.

Each of the plurality of wavelength selection units may include a passive 1:N wavelength demultiplexer for separating the optical signal distributed from the output port of the N×N passive star coupler according to a wavelength; a photo-detector circuit array for converting the optical signal separated from the passive 1:N wavelength demultiplexer into an electrical signal and transmitting the electrical signal to the network controller unit or a (1+N):1 electronic signal switch according to the control signal of the network controller unit; the (1+N):1 electronic switch for selecting any of the electrical signal transmitted from the photo-detector circuit array and the electrical signal transmitted from the network controller unit according to a control signal of the network controller unit and transmitting the selected signal; and a fixed-wavelength transmitter for receiving the electrical signal transmitted from the (1+N):1 electronic switch, converting the electrical signal into an optical signal with an inherent wavelength which is already allocated and transmitting the optical signal with the already allocated inherent wavelength.

The network controller unit may monitor in real time optical layer connection information between all WDMA user interfaces connected to the optical network to manage information of the whole network.

A second aspect of the present invention is to provide a WDMA user interface for an optical layer connection service in an optical network using a WDMA scheme, including: a photo-detector circuit for receiving an optical signal transmitted from a WDMA central station which is responsible for network management and converting the optical signal into an electrical signal; a 1:2 electronic demultiplexer for receiving the converted electrical signal from the photo-detector circuit and transmitting the electrical signal according to a predetermined control signal; a user-station interface for receiving the electrical signal transmitted from the 1:2 electronic demultiplexer and transmitting the electrical signal to a user station, and receiving and transmitting optical layer connection request information and data from the user station; a WDMA access controller for receiving the optical layer connection request information transmitted from the user station interface to produce optical layer connection request signaling information, transferring connection response signaling information received from the WDMA central station to the user station, and controlling operations of the 1:2 electronic demultiplexer and a 2:1 electronic multiplexer according to data receiving/transmitting status; the 2:1 electronic multiplexer for transmitting any one of the electrical signals received from the user-station interface and the WDMA access controller according to a control signal of the WDMA access controller; and a fixed-wavelength transmitter for converting the electrical signal received from the 2:1 electronic multiplexer into an optical signal and transmitting an optical signal with an inherent wavelength which is already allocated, wherein the data and optical layer connection information are transferred between a plurality of user stations in a WDMA manner using an optical signal with an allocated inherent wavelength and respectively connected to the plurality of user stations.

A third aspect of the present invention is to provide an optical layer connection service method in an optical network including a plurality of WDMA user interfaces connected to a user station and a WDMA central station using a WDMA scheme, including: a) among the plurality of WDMA user interfaces, at a source WDMA user interface, receiving an optical layer connection request signal according to a request of the user station and transmitting the optical layer connection request signal to a destination WDMA user interface through the WDMA central station; b) at the destination WDMA user interface, receiving the optical layer connection request signal and transmitting an optical layer connection grant or rejection signal in response to the optical layer connection request signal to the source WDMA user interface through the WDMA central station; c) transmitting a data transmission starting signal to a corresponding user station such that data transmission is performed between the user stations if the source WDMA user interface receives the connection grant response signal; and d) making am optical layer connection reservation if the source WDMA user interface receives the connection rejection response signal.

The optical layer connection request signal may include an address of the destination WDMA user interface, a request connection type, and a connection request class.

The address of the destination WDMA user interface may include at least one of a unicast, a broadcast, and a multicast.

The request connection type may include a point-to-point connection or ring connection type.

The connection request class may include priority order for connection and reservation information.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a schematic diagram of a system employing a wavelength division multiple access (WDMA) central station and a WDMA user interface for an optical layer connection service in an optical network using a WDMA scheme according to an exemplary embodiment of the present invention;

FIG. 2 is a block diagram of a WDMA central station for an optical layer connection service in an optical network using a WDMA scheme according to an exemplary embodiment of the present invention;

FIG. 3 is a block diagram of a WDMA user interface for an optical layer connection service in an optical network using a WDMA scheme according to an exemplary embodiment of the present invention; and

FIG. 4 is a schematic diagram illustrating an optical layer connection service method in an optical network using a WDMA scheme according to an exemplary embodiment of the present invention.

### DETAILED DESCRIPTION OF PREFERRED EMBODIMENTS

The present invention will now be described more fully hereinafter-with reference to the accompanying drawings, in which preferred embodiments of the invention are shown. This invention may, however, be embodied in different forms and should not be construed as limited to the embodiments set forth herein.

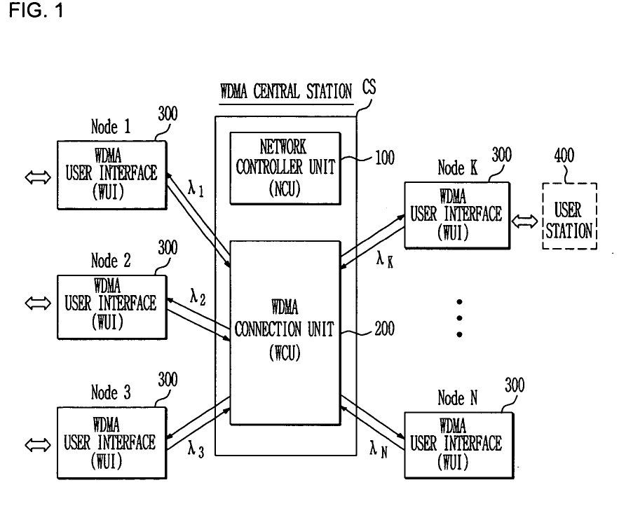

FIG. 1 is a schematic diagram of a system employing a wavelength division multiple access (WDMA) central station and a WDMA user interface for an optical layer connection service in an optical network using a WDMA scheme according to an exemplary embodiment of the present invention.

Referring to FIG. 1, the optical network system includes a WDMA user interface 300 and a WDMA central station CS.

The WDMA user interface 300 is connected to a user station 400 using a WDMA scheme to receive and transmit data and optical layer connection information from and to the user stations 400 through an optical signal having an inherent wavelength which is already allocated.

That is, a plurality of WDMA user interfaces 300 which are respectively located in corresponding nodes Node 1 to Node N are connected to the WDMA central station CS through the optical signal having an inherent wavelength which is already allocated. The WDMA user interface 300 is connected to the user station 400 through existing various protocol interfaces, processes the optical layer connection information from the user station 400, and receives and transmits data from and to the user station 400 through the optical layer connection with the WDMA central station CS. Meanwhile, the user station 400 is not included in the network system of the present invention.

Here, an optical layer connection request signal preferably includes an address of the WDMA user interface 300, a request connection type, and a connection request class.

The address of the WDMA user interface 300 preferably includes at least one of a unicast method, a broadcast method, and a multicast method.

The request connection type preferably includes a point-to-point connection or ring connection type.

The connection request class preferably includes connection priority order and reservation information.

The WDMA central station CS receives the optical signals transmitted from the plurality of WDMA user interfaces 300, distributes and selects the optical signals, transmits them to the respective user stations 400, and provides the connection service in the optical layer according to request quality of the user stations 400.

The WDMA central station CS monitors in real time the optical layer connection information between all WDMA user interfaces 300 connected to the optical network to manage the whole network information.

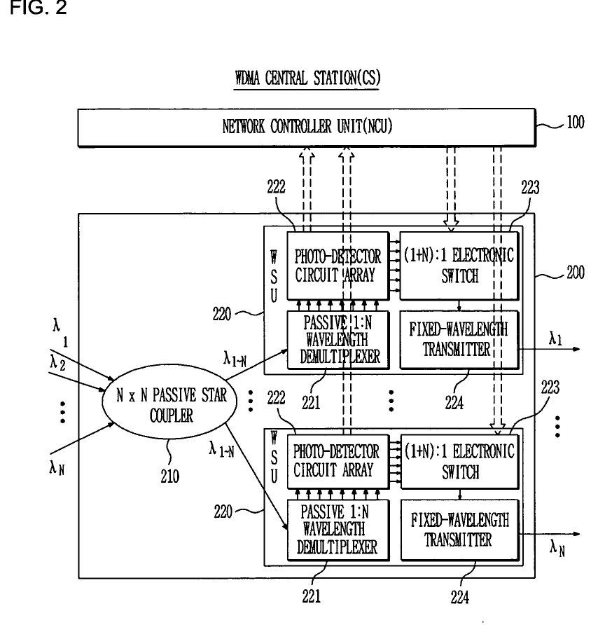

FIG. 2 is a block diagram of a WDMA central station for an optical layer connection service in an optical network using a WDMA scheme according to an exemplary embodiment of the present invention.

Referring to FIG. 2, the WDMA central station CS includes a network controller unit (NCU) 100 and a WDMA connection unit (WCU) 200.

The network controller unit 100 transceives control information related to optical layer connection and network status information received from the plurality of WDMA user interfaces 300 through the WDMA connection unit 200.

The network controller unit 100 transceives the control information related to optical layer connection through centralized control of the WDMA connection unit 200, collects the optical layer network status information and differentiates them according to the request quality, and provides independent optical layer connection service from the upper layer.

The network controller unit 100 performs the typical in-band signaling with the WDMA user interface 300 to perform operations such as optical layer connection control, network status monitoring, and management operation between the user stations 400 connected to the optical network.

Here, the typical in-band signaling method is a method which transmits information within a frequency which is normally used.

The network controller unit 100 receives information from a wavelength selection unit (WSU) 220 of the WDMA connection unit 200 to collect the whole network status information, produces a connection request notify message in response to the connection request among the received information and transmits it to a request destination through the wavelength selection unit 220, and transmits a response message to a request source if a connection grant or rejection message is received from the request destination.

The network controller unit 100 retrieves the collected whole network status information and transmits a connection request message, or transmits a connection rejection message without undergoing a procedure of receiving the connection request grant or rejection message with respect to a destination which is already connected to the other node to transceive data.

The WDMA connection unit 200 receives the optical signals transmitted from the plurality of WDMA user interfaces 300, and distributes and transmits them to the respective user stations 400.

The WDMA connection unit 200 includes an N×N passive star coupler 210 and a plurality of wavelength selection units 220.

The N×N passive star coupler 210 distributes power of the respective input optical signals, connected to the plurality of WDMA user interfaces 300 by the WDMA scheme, by 1/N and outputs to the plurality of wavelength selection units 220 through the respective output ports.

The plurality of wavelength selection units 220 wavelength demultiplexes and convert the optical signals from the output ports of the N×N passive star coupler 210 into electrical signals, and selects any of the converted electrical signals and the electrical signals provided from the network controller unit 100 and converts it into the optical signal having an inherent wavelength which is already allocated and transmits it.

Each of the plurality of wavelength selection units 220 includes a passive 1:N wavelength demultiplexer 221, a photo-detector circuit array 222 with N photo-detector circuits, a (1+N):1 electronic switch 223, and a fixed-wavelength transmitter 224.

The passive 1:N wavelength demultiplexer 221 separates the optical signal distributed from the output port of the N×N passive star coupler 210 according to a wavelength.

The photo-detector circuit array 222 converts the optical signal separated from the passive 1:N wavelength demultiplexer 221 into the electrical signal and transmits the converted signal to the network controller unit 100 or the (1+N):1 electronic switch 223 according to the control signal of the network controller unit 100.

The (1+N):1 electronic switch 223 selects any one of the electrical signal transmitted from the photo-detector circuit array 222 and the electrical signal transmitted from the network controller unit 100 according to the control signal of the network controller unit 100 and transmits it.

The fixed-wavelength transmitter 224 receives the electrical signal transmitted from the (1+N):1 electronic switch 223, converts the electrical signal into the optical signal having an inherent wavelength which is already allocated and transmits it.

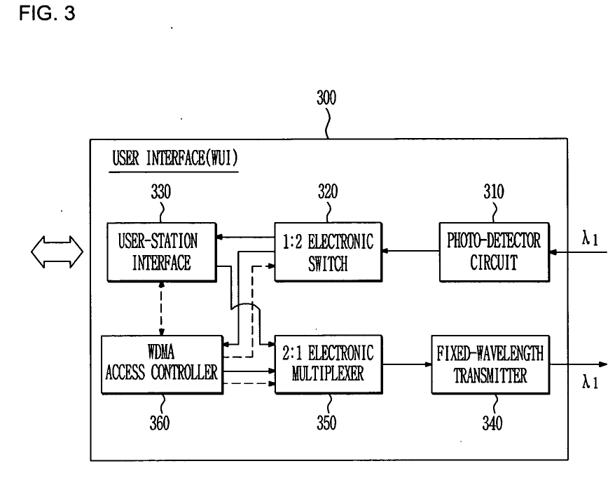

FIG. 3 is a block diagram of a WDMA user interface for an optical layer connection service in an optical network using a WDMA scheme according to an exemplary embodiment of the present invention.

Referring to FIG. 3, the WDMA user interface 300 of the present invention includes a photo-detector circuit 310, a 1:2 electronic demultiplexer 320, a user-station interface 330, a fixed-wavelength transmitter 340, a 2:1 electronic multiplexer 350, and a WDMA access controller 360.

The photo-detector circuit 310 receives an optical signal transmitted from the WDMA central station (CS of FIG. 1) and converts the received optical signal into an electrical signal.

The 1:2 electronic demultiplexer 320 receives the electrical signal from the photo-detector circuit 310 and transmits the received electrical signal according to a control signal of the WDMA access controller 360.

The user-station interface 330 receives the electrical signal from the 1:2 electronic demultiplexer 320 and transmits the received electrical signal to the user station (400 of FIG. 1), and receives the optical layer connection request information and data from the user station 400 and transmits them.

The fixed-wavelength transmitter 340 converts the electrical signal received from the 2:1 electronic multiplexer 350 into the optical signal and transmits the optical signal having an inherent wavelength which is already allocated.

The 2:1 electronic multiplexer 350 transmits any one of the signals received from the user-station interface 330 and the WDMA access controller 360 to the fixed-wavelength transmitter 340 according to the control signal of the WDMA access controller 360.

The WDMA access controller 360 receives the optical layer connection request information transmitted from the user station interface 330 to produce the optical layer connection request signaling information, transfers the connection response signaling information received from the WDMA central station CS to the user station 400, and controls operations of the 1:2 electronic demultiplexer 320 and the 2:1 electronic multiplexer 350 according to data receiving/transmitting status.

The WDMA user interface 300 having configuration described above provides the independent connection service from an upper layer protocol in which the existing user stations have through the standardized interfaces of the user station and communicates with the WDMA central station CS in the typical in-band signaling manner.

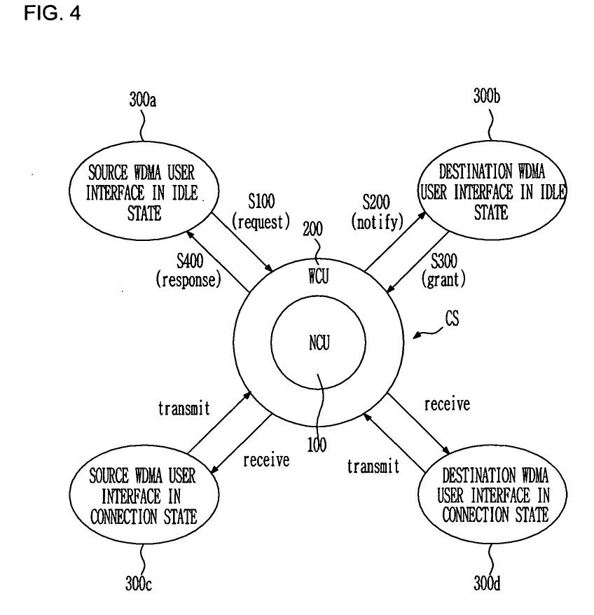

FIG. 4 is a schematic diagram illustrating an optical layer connection service method in an optical network using a WDMA scheme according to an exemplary embodiment of the present invention.

Referring to FIG. 4, among the plurality of WDMA user interfaces (300 of FIG. 1), a source WDMA user interface 300a which is in an idle state receives an optical layer connection request signal according to a request of the user station (400 of FIG. 1) and transmits the received optical layer connection request signal to a destination WDMA user interface 300b which is in an idle state through the WDMA central station CS (steps S100 and S200).

In more detail, the WDMA access controller (360 of FIG. 3) of the source WDMA user interface 300a which is in an idle state receives the optical layer connection request signal, produces a connection request message to be transmitted to the network controller unit 100 of the WDMA central station CS, and transmits the connection request message to the WDMA central station CS through the 2:1 electronic multiplexer (350 of FIG. 3) and the fixed-wavelength transmitter (340 of FIG. 3) (step S100).

Then, the WDMA central station CS receives the connection request message transmitted from the source WDMA user interface 300a which is in an idle state, produces a connection request notify message and transmits the connection request notify message to the destination WDMA user interface 300b which is in an idle state (step S200).

Here, the optical layer connection request signal includes information such as an address of the destination WDMA user interface 300b, a request connection type, and a connection request class. The address of the destination WDMA user interface 300b includes a unicast, a broadcast or a multicast, the request connection type includes a point-to-point connection or ring connection type, and the connection request class includes connection priority order and reservation information.

Next, the designation WDMA user interface 300b which is in an idle state receives the optical layer connection request signal and transmits a connection grant or rejection message as a connection response to the source WDMA user interface 300a which is in an idle state through the WDMA central station CS (steps S300 and S400).

In more detail, the destination WDMA user interface 300b which is in an idle state receives the connection request notify message transmitted from the WDMA central station CS, and produces a message which grants or rejects optical layer connection and transmits it to the WDMA central station CS (step S300).

Then, when the connection grant message is received from the destination WDMA user interface 300b which is in an idle state, the WDMA central station CS transmits a connection grant response message to the source WDMA user interface 300a which is in an idle state (step S400), and the source WDMA user interface 300a which is in an idle state receives the connection grant response message and transmits a data transmission/reception starting message to the corresponding user station 400.

However, when the connection rejection message is received from the destination WDMA user interface 300b, the WDMA central station CS transmits a connection rejection response message to the source WDMA user interface 300a which is in an idle state (step S400), and the source WDMA user interface 300a which is in an idle state receives the connection rejection response message and makes a connection reservation or tries connecting to the other WDMA user interface having a different address.

As described above, the WDMA central station CS receives various information data between the user stations from the plurality of WDMA user interfaces 300 to collect the whole network status information. If it receives the optical layer connection request signal, the WDMA central station CS produces the connection request notify message and transmits it to the destination WDMA user interface 300b, receives the optical connection grant or rejection message as a response message from the destination WDMA user interface 300b, and transmits the connection response message to the source WDMA user interface 300a.

The WDMA central station CS retrieves the collected whole network status information, and if it receives a connection request signal which requests connection to the WDMA user interface 300c or 300d which is already connected to the WDMA user interface 300 and receives/transmits various information data from/to the WDMA user interface 300, it can transmit a connection rejection response message to the corresponding source WDMA user interface 300.

The WDMA central station CS can perform optical layer connection control, network status monitoring, and management operations between the user stations 400 connected to the optical network system using a typical in-band signaling manner.

Meanwhile, signaling for the connection request signal and the connection response signal transmitted between the WDMA central station CS and the WDMS user interfaces 300a to 300d is preferably performed in the in-band signaling manner such that the same optical layer connection as the data transmission network can be used.

That is, there is an advantage in that additional signaling network does not need to be used by applying the in-band signaling manner which uses the same optical layer connection as the data transmission network.

As described herein before, according to the WDMA central station, the WDMA user interface, and the optical layer connection service method in the optical network using WDMA, there are advantages in that it is possible to sternly design and manage wavelength trouble and noise and to implement the WDMA user interface which has quality stability of the optical signal, short connection setting signal, and are low in cost and simple, by employing the in-band signaling method, the centralized control structure, and the fixed-wavelength optical element.

Further, according to the present invention, there are advantages in that network security and stability, traffic monitoring, and fast connection service can be provided, the user stations which are protocol-transparent and have various protocols can be used by employing the independent in-band signaling method from the upper layer, and the optical layer connection service differentiated by the request connection type and the request connection priority order of the user stations can be provided.

Although exemplary embodiments of the present invention have been described with reference to the attached drawings, the present invention is not limited to these embodiments, and it should be appreciated to those skilled in the art that a variety of modifications and changes can be made without departing from the spirit and scope of the present invention.

What is claimed is:

1. A wavelength division multiple access (WDMA) central station for an optical layer connection service in an optical network using a WDMA scheme, the station comprising:
a WDMA connection unit for receiving optical signals transmitted from a plurality of WDMA user interfaces, distributing and selecting the optical signals, and transmitting the distributed and selected optical signals to a plurality of user stations; and
a network controller unit for transceiving control information related to optical layer connection and network status information received from the plurality of WDMA user interfaces through the WDMA connection unit,
wherein an optical layer connection service is provided according to request quality of the plurality of user stations.

2. The WDMA central station as recited in claim 1, wherein the WDMA connection unit includes:
a N×N passive star coupler for distributing power of respective input optical signals connected to the plurality of WDMA user interfaces in a WDMA manner by 1/N to respective output ports; and
a plurality of wavelength selection units for converting the optical signals distributed from the output ports of the N×N passive star coupler into a wavelength demultiplexing and electrical signal, and selecting any one of the converted electrical signal and an electrical signal provided from the network controller unit to convert the selected signal into an optical signal with an inherent wavelength which is already allocated and transmit the optical signal.

3. The WDMA central station as recited in claim 2, wherein each of the plurality of wavelength selection units includes:
a passive 1:N wavelength demultiplexer for separating the optical signal distributed from the output port of the N×N passive star coupler according to a wavelength;
a photo-detector circuit array for converting the optical signal separated from the passive 1:N wavelength demultiplexer into an electrical signal and transmitting the electrical signal to the network controller unit or a (1+N):1 electronic signal switch according to the control signal of the network controller unit;
the (1+N):1 electronic switch for selecting any of the electrical signal transmitted from the photo-detector circuit array and the electrical signal transmitted from the network controller unit according to a control signal of the network controller unit and transmitting the selected signal; and
a fixed-wavelength transmitter for receiving the electrical signal transmitted from the (1+N):1 electronic switch, converting the electrical signal into an optical signal with an inherent wavelength which is already allocated and transmitting the optical signal with the already allocated inherent wavelength.

4. The WDMA central station as recited in claim 1, wherein the network controller unit monitors in real time optical layer connection information between all WDMA user interfaces connected to the optical network to manage information of the whole network.

5. The WDMA central station as recited in claim 1, wherein the network controller unit transceives control information related to optical layer connection and collects optical layer network status information through centralized control of the WDMA connection unit, so that optical layer connection service which is differentiated and independent from an upper layer are provided.

6. The WDMA central station as recited in claim 1, wherein the network controller unit performs optical layer connection control, network status monitoring, and management operation between a plurality of user stations which are connected to the optical network using an in-band signaling manner with the plurality of WDMA user interfaces.

7. A WDMA user interface for an optical layer connection service in an optical network using a WDMA scheme, the WDMA user interface comprising:
a photo-detector circuit for receiving an optical signal transmitted from a WDMA central station which is responsible for network management and converting the optical signal into an electrical signal;
a 1:2 electronic demultiplexer for receiving the converted electrical signal from the photo-detector circuit and transmitting the electrical signal according to a predetermined control signal;
a user-station interface for receiving the electrical signal transmitted from the 1:2 electronic demultiplexer and transmitting the electrical signal to a user station, and receiving and transmitting optical layer connection request information and data from the user station;
a WDMA access controller for receiving the optical layer connection request information transmitted from the user station interface to produce optical layer connection request signaling information, transferring connection response signaling information received from the WDMA central station to the user station, and controlling operations of the 1:2 electronic demultiplexer and a 2:1 electronic multiplexer according to data receiving/transmitting status;
the 2:1 electronic multiplexer for transmitting any one of the electrical signals received from the user-station interface and the WDMA access controller according to a control signal of the WDMA access controller; and
a fixed-wavelength transmitter for converting the electrical signal received from the 2:1 electronic multiplexer into an optical signal and transmitting an optical signal with an inherent wavelength which is already allocated, ‘wherein the data and optical layer connection information are transferred between a plurality of user stations in a WDMA manner using an optical signal with an allocated inherent wavelength and respectively connected to the plurality of user stations.

8. An optical layer connection service method in an optical network including a plurality of WDMA user interfaces connected to a user station and a WDMA central station using a WDMA scheme, the method comprising:
a) among the plurality of WDMA user interfaces, at a source WDMA user interface, receiving an optical layer connection request signal according to a request of the user station and transmitting the optical layer connection request signal to a destination WDMA user interface through the WDMA central station;
b) at the destination WDMA user interface, receiving the optical layer connection request signal and transmitting an optical layer connection grant or rejection signal in response to the optical layer connection request signal to the source WDMA user interface through the WDMA central station;
c) transmitting a data transmission starting signal to a corresponding user station such that data transmission is performed between the user stations if the source WDMA user interface receives the connection grant response signal; and
d) making am optical layer connection reservation if the source WDMA user interface receives the connection rejection response signal.

9. The method as recited in claim 8, wherein the optical layer connection request signal includes an address of the destination WDMA user interface, a request connection type, and a connection request class.

10. The method as recited in claim 9, wherein the address of the destination WDMA user interface includes at least one of a unicast, a broadcast, and a multicast.

11. The method as recited in claim 9, wherein the request connection type includes a point-to-point connection or ring connection type.

12. The method as recited in claim 9, wherein the connection request class includes priority order for connection and reservation information.

13. The method as recited in claim 8, wherein at the steps a) and b), the WDMA central station receives various information data of the user stations from the plurality of WDMA user interfaces to collect the whole network status information, and produces a predetermined connection request notify message and transmits the connection request notify message to the destination WDMA user interface if the optical connection request signal is received, and receives the optical layer connection grant or rejection signal from the destination WDMA user interface and transmits the optical layer connection grant or rejection signal to the source WDMA user interface.

14. The method as recited in claim 13, wherein the WDMA central station retrieves the collected whole network status information and transmits the connection rejection response signal to the source WDMA user interface when receiving the connection request signal for the WDMA user interface which is already connected to perform data transmission.

15. The method as recited in claim 8, further comprising, at the step d), trying connecting to a WDMA user interface having a different address if the source WDMA user interface receives the connection rejection response signal.

16. The method as recited in claim 8, wherein signaling for the connection request signal and the connection response signal transceived between the WDMA central station and the WDMS user interfaces is performed in an in-band signaling manner to use the optical layer connection which is equal to the data transmission network.

17. The method as recited in claim 16, wherein the WDMA central station performs optical layer connection control, network status monitoring, and management operation between the user stations which are connected to the optical network using the in-band signaling manner.
